(19) United States
(12) Patent Application Publication
(10) Pub. No.: US 2008/0047174 A1
(43) Pub. Date: Feb. 28, 2008

(54) WALL COVERING SAMPLE HOLDERS

(76) Inventors: Robert Lehrmitt, Austin, TX (US); Sharon L. Drinkwine, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/751,300

(22) Filed: May 21, 2007

Related U.S. Application Data
(60) Provisional application No. 60/812,318, filed on Jun. 9, 2006.

(51) Int. Cl. G09F 1/10

(52) U.S. Cl. 40/124.06

(57) ABSTRACT

A sample card display system is described. The sample card display system includes a holder with at least two sides substantially opposed to each other. Each of the two substantially opposed sides may include at least one protrusion. A plurality of sample cards may be placed in the holder. At least two of the sample cards may include at least two notches on opposing sides of the sample cards. The notches may couple with protrusions on sides of the holder such that the sample cards are detachably held within the holder.

### PRIORITY CLAIM

This patent application claims priority to U.S. Provisional Patent No. 60/812,318 entitled “WALL COVERING SAMPLE HOLDERS” to Lehrmitt et al. filed on Jun. 9, 2006.

### BACKGROUND

1. Field of the Invention

The present invention relates generally to wall covering sample cards. Certain embodiments relate to holders for securing and displaying wall covering sample cards.

2. Description of Related Art

Sample books and/or sample holders are used in interior decorating and other industries for displaying samples of patterns such as wall covering patterns, wallpaper patterns, carpet patterns, fabric patterns, and/or paint patterns. Sample books and/or sample holders may display in a single book or holder a plurality of different sample patterns. Sample books or holders are often viewed by a user (e.g., consumers or customers) so that the user may select a pattern to use for interior decoration and/or purchase. The sample books and/or holders may be placed in, for example, an architect's or designer's office where the user can view the sample patterns and make a decision regarding the sample patterns. Sample books and/or holders typically hold a large number of sample patterns so that the user has a large number of options. Sample books and/or holders may display patterns from one or more sources (e.g., manufacturer, suppliers, or distributors).

Typically, sample books and/or holders hold sample patterns on sample cards in a binder or in a binding fashion. These sample books and/or holders may be bulky and heavy as they bind together a large number of different samples cards. These sample books and/or holders may also be cumbersome for a user to view sample patterns as the user has to flip through the sample cards one by one by turning or flipping over cards in a binder. In addition, it may be difficult to reorganize the binder when sample patterns are removed and/or added. Sample card holders are also subject to abuse and/or misuse by a user. Abuse and/or misuse by the user of the sample card holder may include dropping of the sample card holder, frequent turning of the sample cards, and inserting and/or removing sample cards from the holder.

### SUMMARY

A sample card holder is provided that allows sample patterns to be easily viewed by a user. The sample card holder may also allow for simple removal, addition, and organization of sample patterns to keep the sample card holder up to date. In addition, the sample card holder may protect the sample patterns from wear and tear due to normal wear and tear, abuse and/or misuse of the sample cards and/or sample card holder.

In certain embodiments, a sample card display system includes a holder and one or more sample cards that fit in the holder. The holder may include at least two sides substantially opposed to each other. Each of the at least two of the sides substantially opposed to each other may include at least one protrusion. The sample cards may include at least two notches on opposing sides of the sample cards. The notches may couple with protrusions on sides of the holder such that the sample cards are detachably held within the holder.

In certain embodiments, a sample card for the holder may be an envelope that contains a number of samples. The samples in the envelope may be arranged in a staggered or stair-step fashion so that a user is able to view two or more samples with a single look. A cover may close the envelope. The envelope includes an opening that allows the user to view two or more sample cards in the envelope.

### BRIEF DESCRIPTION OF THE DRAWINGS

Advantages of the present invention may become apparent to those skilled in the art with the benefit of the following detailed description and upon reference to the accompanying drawings in which:

FIG. 1 depicts an embodiment of a sample card in a holder.

FIG. 2 depicts an embodiment of a plurality of sample cards in a holder.

FIG. 3 depicts an embodiment of an accordion style sample card.

FIG. 4 depicts an embodiment of a sample card holder with a cover in a closed position.

FIG. 5 depicts an embodiment of the sample card holder shown in FIG. 4 with the cover in an open position.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION

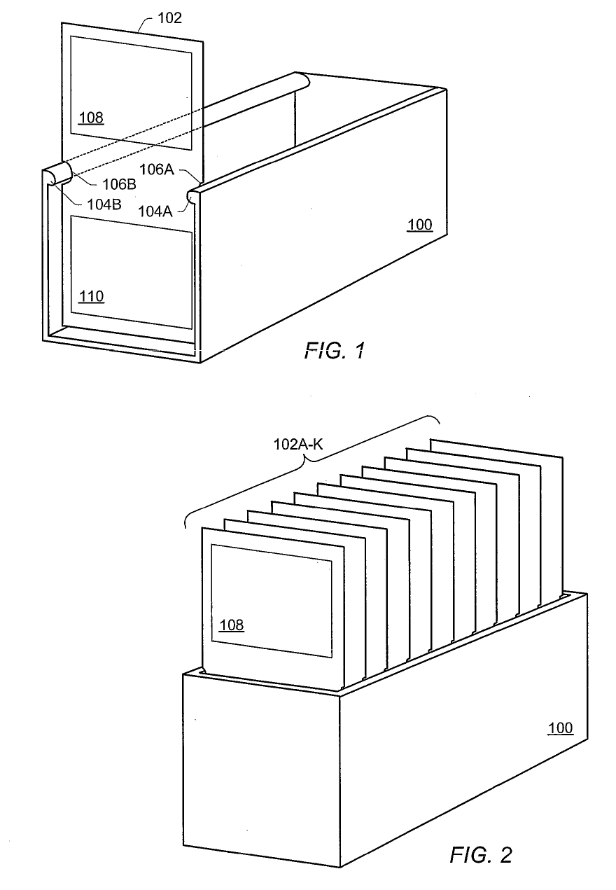

FIG. 1 depicts an embodiment of a sample card in a holder. Holder 100 may be a container or other suitable device for holding one or more sample cards 102. In certain embodiments, holder 100 is a container such as a box with at least one opening. Holder 100, as shown in FIG. 1, is a box with an open top. The front face of holder 100 in FIG. 1 has been cut away for clarity. Holder 100 has an interior space that allows a portion of sample card 102 to fit into the interior of the holder. In certain embodiments, holder 100 may have an interior shape that matches a shape of sample card 102.

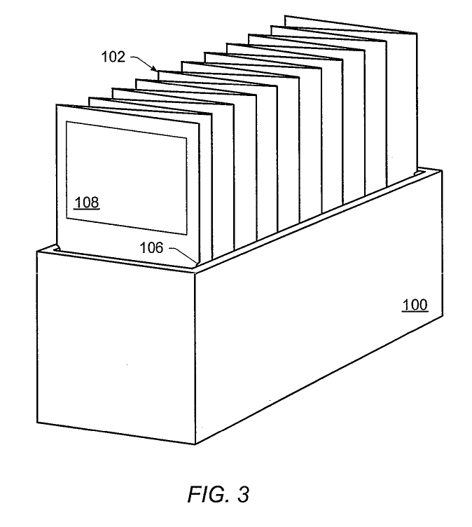

In certain embodiments, holder 100 is made of plastic and/or another suitable material (e.g., wood, metal, or ceramic). In some embodiments, holder 100 is made of injection molded material such as injection molded plastic. Holder 100 may be able to hold and support a plurality of sample cards 102A-102K, as shown in FIG. 2. In some embodiments, holder 100 includes a ring or other device for hanging or mounting the holder to a fixture.

In certain embodiments, holder 100 has opposing sides with protrusions 104A, 104B on each of the opposing sides. In some embodiments, opposing sides of holder 100 may have more than one protrusion 104 (e.g., two protrusions or three protrusions). In certain embodiments, protrusions 104A, 104B are lips formed in the sides of holder 100. For example, protrusions 104A, 104B may be formed during an injection molding process to make holder 100. Protrusions 104A, 104B may have any shape that corresponds to a shape of notches 106A, 106B in sample card 102. For example, protrusions 104A, 104B may be rounded protrusions, as shown in FIG. 1, or the protrusions may jut out to a sharp point (such as in a triangular shape).

Notches 106A, 106B are shaped to couple with protrusions 104A, 104B so that sample card 102 is held in holder 100 when the notches are coupled with the protrusions. Sample card 102 may be detachably held in holder 100 when notches 106A, 106B are coupled to protrusions 104A, 104B. Sample card 102 may be placed in holder 100 by turning, bending, flexing, and/or twisting the sample card so that the sample card may be slid into the holder. As the sample card 102 is placed in holder 100, the sample card may be turned, bent, flexed, and/or allowed to untwist as notches 106A, 106B align with protrusions 104A, 104B to couple the notches to the protrusions and hold (e.g., detachably hold) the sample card in the holder.

Sample card 102 is held in holder 100 with notches 106A, 106B and protrusions 104A, 104B so that the sample card will not fall out when the holder is, for example, moved or turned upside down. Sample card 102 is held in holder 100 so that the sample card is only removed from the holder when a user facilitates removal of the sample card from the holder. A user may remove sample card 102 from holder 100 by turning, bending, flexing, and/or twisting the sample card so that notches 106A, 106B are uncoupled from protrusions 104A, 104B. Sample card 102 may then be pulled out of holder 100.

When a plurality of sample cards 102A-102K are in holder 100, as shown in FIG. 2, a user may view portions of the sample cards that are not inside of the holder (e.g., the upper portions of the sample cards). These visible portions of sample cards 102A-102K may include sample pattern 108. Each of sample cards 102A-102K may have a different sample pattern. Sample patterns 108 may include, but is not limited to, wall covering patterns, wallpaper patterns, carpet patterns, fabric patterns, and paint patterns.

A user may browse through sample cards 102A-102K by leafing through the sample cards (e.g., riffling through, thumbing through, shuffling through, or otherwise viewing the cards by slightly bending or moving the cards so that each card becomes visible to the user). Leafing through sample cards 102A-102K allows the user to easily view several sample patterns 108. In some embodiments, the user may quickly view several sample patterns 108 or, in some embodiments, substantially simultaneously several sample patterns.

In some embodiments, the user may choose to view one or more sample patterns 108 in more detail. For a more detailed view of the sample patterns, the user may remove one or more sample cards 102 with the desired sample patterns. For example, the user may remove the sample card to feel a texture of the sample pattern or to view finer details in the sample pattern.

In certain embodiments, sample card 102 includes information about the sample pattern on portions of the sample card unviewable by the user when the sample card is in holder 100 (e.g., portion 110 as shown in FIG. 1). For example, portion 110 may include information such as, but not limited to, additional samples, additional colors available for the pattern, additional patterns available for the color, manufacturer information, distributor information, availability, delivery information, and/or price.

In certain embodiments, sample patterns 108, as shown in FIG. 2, are large enough to be easily viewed by leafing through sample cards 102A-102K. This allows a user to quickly and efficiently view the sample patterns. In addition, holder 100 is essentially “always open” because a lid, cover, or top is not needed to hold the sample cards in the holder.

Sample cards 102A-102K may also be easily removed and/or added to holder 100. Any of sample cards 102A-102K may be, for example, easily replaced with a new sample card when a sample pattern is discontinued, has been replaced with a newer sample pattern, or the sample pattern has worn out and needs replacing. Additional sample cards may be easily placed anywhere in holder 100 as desired. For example, a provider of the sample patterns (e.g., an architect or an interior designer) may wish to place newer sample patterns at a front end of holder 100 so that the user views newer sample patterns first. Thus, sample cards 102A-102K may be removed and/or added to holder 100 without having to replace holder 100 and/or the entire collection of sample cards.

In some embodiments, sample cards 102A-102K have large widths (for example, the distance between notches) so that sample patterns 108 may have a large display area. In some embodiments, sample cards 102A-102K have a ring or other device attached so that the sample cards may be placed in a sample binder or sample book. For example, sample cards 102A-102K may be placed in a sample binder or sample book during a transition period between using the sample binder or sample book and holder 100. In some embodiments, sample cards 102A-102K may be placed in a sample binder or sample book for transport when use of holder 100 is not feasible.

In some embodiments, a sample card may be an accordion card. FIG. 3 depicts an embodiment of an accordion card. Sample card 102 may include two end pieces with notches 106 that mate with corresponding protrusions of holder 100. Viewable material may be positioned on pages between the two end pieces. The pages may be folded between the two end pieces. In some embodiments, the accordion card may be removed from holder and spread out on a flat surface to facilitate viewing the individual pages of the accordion card. In some embodiments, an accordion card may include samples of product available from a specific manufacturer or supplier. In some embodiments, an accordion card may include samples of colors and/or material available for a particular article (e.g., a chair, sofa or other piece of furniture).

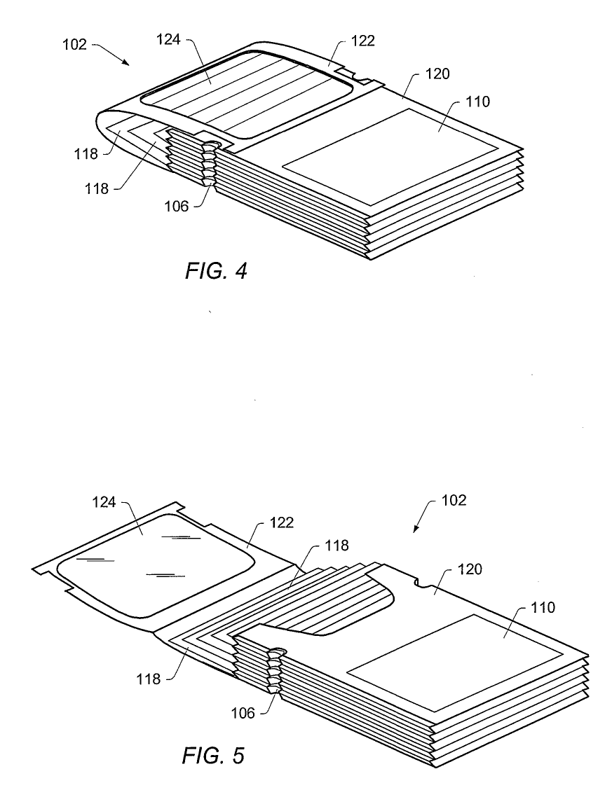

FIG. 4 depicts an embodiment of sample card 102 that is able to hold a number of samples 118. A cover of sample card 102 is in a closed position. FIG. 5 depicts the embodiment of sample card 102 shown in FIG. 4 with the cover in an open position. Sample card 102 may include envelope 120 or other suitable device for holding one or more samples 118. In certain embodiments, envelope 120 is an expandable folder with an opening that allows samples 118 to be placed in the envelope. Envelope 120 may be able to expand or contract depending on the number of samples 118 in the envelope. For example, the sides of envelope 120 may be flexible (e.g., accordion shaped) so that the envelope may expand and/or contract as needed. Flexibility allows envelope 120 to firmly hold varying numbers and/or thicknesses of samples 118. In some embodiments envelope 120 does not include flexible sides that allow for expansion and/or contraction of the envelope.

Samples 118 may be inserted into and removed from envelope 120 when cover 122 is in the open position. As shown in FIG. 5, samples 118 are arranged in envelope 120 so that a portion of each sample card is visible (e.g., the sample cards are at least partially staggered, offset or stair-stepped). Having a portion of each sample 118 at least partially visible allows a user to view each of the samples in envelope 120 with a single look. The visible portions of samples 118 may include sample colors and/or sample patterns. When cover 122 is in the closed position, as shown in FIG. 4, sample colors and/or sample patterns on the sample cards are at least partially visible through opening 124 in the cover. In some embodiments, cover 122 may be sealed against the body of envelope 120 to inhibit reopening of the envelope after samples 118 are placed in the envelope. In some embodiments, cover 122 may be sealed against the body of envelope 118 so that the envelope may be later reopened.

Opening 124 may be a window (e.g., a transparent plastic window) or other transparent opening that allows the user to view portions of samples 118 through cover 122. In some embodiments, opening 124 includes visibly transparent materials that allow the user to view samples 118 while protecting the samples from dust, spills, light, other environmental degradation, user contact, or other contact that may degrade the samples. For example, opening 124 may include visibly transparent materials that are opaque to ultraviolet radiation or other radiation that may fade or wear out the samples.

In some embodiments, the opening of the sample card is not located on the cover of the envelope. The opening is located on a surface of the envelope opposite to the surface to which the cover is attached.

In certain embodiments, the user views one or more sample colors on samples 118 through opening 124, as shown in FIG. 4. Sample card 102 may be positioned in the holder (e.g., holder 100 depicted in FIG. 1). Sample card 102 may be one of several sample cards positioned in holder 100. Some sample cards 102 may be envelopes with covers. If desired, the user may remove sample card 102 from holder 100. Information regarding samples viewable through opening 124 may be placed on portion 110 of sample card 102. For example, the user may be able to view the sample pattern, color information, and/or other information displayed on the sample card (e.g., pattern name, pattern color, other available colors or patterns, manufacturer information, distributor information, availability, delivery information, and/or price).

Envelope 120 may be made of plastic or other lightweight, durable material that protects samples 118 positioned in the envelope. Envelope 120 may protect the edges of samples 118 from being worn or frayed during use of the envelope. Thus, samples 118 may have a long lifetime when positioned in envelope 120. Envelope 120 and samples 118 may remain in good condition while being viewed, used, and/or handled by numerous users.

In certain embodiments, envelope 120 may includes one or more notches 106. Notches 106 allow envelope 120 to be placed in and detachably held in holder 100, shown in FIGS. 1 and 2. Notches 106 in envelope 120 may be aligned and coupled with protrusions 104A, 104B in holder 100 so that envelope 120 is detachably held in holder 100.

The holder may hold various types of sample cards. For example, the holder may hold one or more single sample cards (such as the sample cards depicted in FIG. 1), one or more accordion style sample cards, and/or one or more sample cards with an opening that allows a user to see several samples included in the sample card.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A sample card display system, comprising:
a holder comprising at least two sides substantially opposed to each other, wherein each of the at least two of the sides substantially opposed to each other comprise at least one protrusion; and
a plurality of sample cards, wherein at least two of the sample cards comprises at least two notches on opposing sides of the sample cards, the notches being configured to couple with protrusions on sides of the holder such that the sample cards are detachably held within the holder.

2. The system of claim 1, wherein at least one of the sample cards is configured to be twisted so that the card can be placed in the holder by aligning the notches on the sample card with the protrusions on the holder.

3. The system of claim 1, wherein at least one of the sample cards is configured to be turned so that the card can be placed in the holder by aligning the notches on the sample card with the protrusions on the holder.

4. The system of claim 1, wherein at least one of the sample cards is configured to be removed from the holder by turning and/or twisting the card so that the notches are uncoupled from the protrusions and then pulling the card out of the holder.

5. The system of claim 1, wherein at least one of the sample cards comprises a sample pattern.

6. The system of claim 1, wherein at least one of the sample cards comprises a portion viewable to a user of the system when the sample card is in the holder.

7. The system of claim 6, wherein the portion viewable to the user comprises a sample pattern.

8. The system of claim 1, wherein at least two of the sample cards comprise portions substantially simultaneously viewable to a user of the system when the sample cards are in the holder.

9. The system of claim 1, wherein at least one of the sample cards comprises a portion unviewable to a user of the system when the sample card is in the holder.

10. The system of claim 9, wherein the unviewable portion comprises information about a sample pattern on the sample card.

11. The system of claim 1, wherein the holder comprises a box with an opening for allowing the cards to be placed in the holder.

12. The system of claim 1, wherein the plurality of sample cards comprise sample patterns, and wherein the holder is configured to allow a user to view the sample patterns without removing the sample cards from the holder.

13. The system of claim 1, wherein the sample cards are detachably held within the holder such that the sample cards remain in the holder until a user facilitates removal of the sample cards.

14. The system of claim 1, wherein at least one of the protrusions comprises a lip along formed along a side of the holder.

15. A wall covering sample card display system, comprising:
a holder comprising at least two sides substantially opposed to each other, wherein each of the at least two of the sides substantially opposed to each other comprise at least one protrusion; and
a plurality of wall covering sample cards, wherein at least two of the sample cards comprises at least two notches on opposing sides of the sample cards, the notches being configured to couple with protrusions on sides of the holder such that the sample cards are detachably held within the holder.

16. A sample card, comprising:
an envelope for holding a plurality of samples, wherein the samples are configured to be located in the envelope with at least a portion of at least one sample offset from at least a portion of another sample such that a user is simultaneously able to view portions of at least two of the samples;
a cover coupled to the envelope, wherein the cover is configured to enclose the samples in the envelope; and
an opening in the envelope to allow the user to view at least a portion of two or more samples in the envelope.

17. The system of claim 16, wherein the portions of the samples comprise sample patterns.

18. The system of claim 16, wherein the portions of the samples comprise sample colors.

19. The system of claim 16, wherein the samples are at least partially offset so that the portions of the samples are simultaneously viewable to the user.

20. The system of claim 16, further comprising at least one notch, wherein the notch is configured to mate with a protrusion of a holder.

21. The system of claim 20, wherein a portion of the envelope comprises information about at least one of the samples.

22. The system of claim 16, wherein the envelope comprises an expandable folder with an opening for allowing the cards to be placed in the envelope.

23. A wall covering sample card display system, comprising:
an envelope for holding a plurality of wall covering samples, wherein the wall covering samples are configured to be located in the envelope with at least a portion of at least one wall covering sample offset from at least a portion of another wall covering sample such that a user is simultaneously able to view portions of at least two of the wall covering samples;
a cover coupled to the envelope, wherein the cover is configured to enclose the wall covering samples in the envelope; and
an opening in the envelope to allow the user to view at least a portion of two or more wall covering samples in the envelope.
